(19) United States
(12) Patent Application Publication
(10) Pub. No.: US 2010/0175326 A1
(43) Pub. Date: Jul. 15, 2010

(54) Door Operator

(75) Inventor: Matthias DRUX, Gevelsberg (DE)

Correspondence Address: COHEN, PONTANI, LIEBERMAN & PAVANE LLP, 551 FIFTH AVENUE, SUITE 1210, NEW YORK, NY, 10176, US

(73) Assignee: Dorma GmbH+Co. KG, Ennepetal (DE)

(21) Appl. No.: 12/684,568

(22) Filed: Jan. 8, 2010

(30) Foreign Application Priority Data
Jan. 9, 2009 (DE) 10 2009 004 509.0

(51) Int. Cl. E05F 15/00; E05F 11/00; E06B 3/00; C08F 14/06; C08G 63/02; C08F 120/18; C08G 64/00; C08F 220/44

(52) U.S. Cl. 49/348; 49/324; 49/507; 526/344; 528/272; 526/329.7; 528/196; 526/342

(57) ABSTRACT

A door operator is provided for operating a door leaf of a door, in particular of a swing leaf door or of a sliding door, having at least one structural member made from a plastic material. The at least one of the structural member is made from at least one of a flame-resistant material and self-extinguishing plastic material.

### FIELD OF THE INVENTION

The present invention relates to a door operator for operating a door leaf of a door, in particular of a swing leaf door or of a sliding door.

### BACKGROUND OF THE INVENTION

Door operators of the present type can be used as door closers or as electrically operated door drives. If the door operator is formed as a door closer, the door operator includes a spring force accumulator, in which a potential energy, originating from the manually executed opening movement of the door leaf, can be stored. Such energy is sufficient for subsequently executing a closing movement of the door leaf. If the door operator is formed as an electrical door drive, the latter is able to execute both the opening movement and the closing movement of the door leaf.

Door operators are parts of modern building engineering and therefore must comply with existing safety regulations. In particular if a door operator is disposed at a door located in an escape route of a building, the door operator has to meet considerable safety requirements.

In such a case, in particular a reliable functioning of the door operator is emphasized, if an emergency situation occurs in said building. This situation may occur for example in case of fire, power failure or other emergency occurrence.

In particular in the event of a fire, the door operators must meet special requirements, such that a trouble-free continued operation of the door operator is guaranteed. If the door operator is formed as an electrical door drive, the door leaf must be manually operable in the event of power failure.

### SUMMARY OF THE INVENTION

It is an object of the present invention to further improve functional reliability of door operators in an emergency state of a building.

The invention relates to a door operator, in which at least one of the structural members of the door operator is made from a flame-resistant and/or self-extinguishing plastic material.

Door operators for operating a door leaf of a door are predominantly installed at the door leaf, at the door post or at a wall adjacent to the door. In the event of a fire, the door operator may be exposed to considerable heat and in particular to an ignition source, such that the components of the door operator made from plastic material may start to burn. This may have the consequence that the door operator might fail to function, even though the power supply is still operable despite the fire. This failure may cause a door leaf to automatically close or prevent or make difficult manual opening the door. As a consequence, the safety offered by the door operator is considerably compromised. If one or more of the structural members of the door operator are made from a flame-resistant and/or self-extinguishing plastic material, the continued functioning of the door operator, even in the event of fire, can be improved.

Plastic materials are known to have flame-resistant behavior. More specifically, several types of flame-resistant plastic materials are known, which contain flame-proofing agents based on halogen, nitrogen or organic phosphorus. Furthermore, inorganic flame-proofing agents are known. The mechanical features of such plastic materials can be essentially maintained despite the flame-resistant features.

Many of the above mentioned flame-proofing agents furthermore include a self-extinguishing feature, such that, after an ignition source is removed, the plastic material automatically extinguishes within a short period of time and thus does not continue to burn. According to DIN 4102, self-extinguishing plastic materials offer a high fire resistance, which is measured by the duration during which a structural member keeps its proper functioning in the event of a fire. As a consequence, the plastic material structural members of the inventive door operator can comply with DIN 4102. In the event DIN 4102 will be repealed in the near future, the inventive door operator can comply with DIN EN 13501-1 by selecting the plastic material structural members among a flame-resistant and/or self-extinguishing plastic material.

A flame-resistant polymer is known for example from DE 10 2005 050 704 A1. By way of example, the here suggested plastic material is based on a composition of five components A, B, C, D and E, comprising component A: 40 to 90 weight percent polymer, B: 0 to 40 weight percent reinforcing material, C: 3 to 15 weight percent red phosphorus, D: 5 to 20 weight percent inorganic phosphate, and E: 0 to 10 weight percent further additives, wherein the sum of the mentioned components always adds up to 100 weight percent. Self-extinguishing plastic materials are thereby provided which comply with the fire safety standards required in the electrical and electronic sector, are easy to work with and have sufficient mechanical features in order to be acceptable as structural members for a door operator.

In particular the cables, existing in a door operator, may be formed of a flame-resistant and/or self-extinguishing material. In this case, PVC has proven to be a reliable and safe cable material, because standard PVC cables are flame-resistant and self-extinguishing without adding flame-retardant additives. In particular in the event of a short-circuit or thermal overload of a door operator, PVC-based cables allow for considerably increased operational reliability of the door operator.

It is of particular advantage if the flame-resistant and/or self-extinguishing plastic material of the at least one structural member of the door operator complies with the classification according to UL94. The flammability of plastic materials can be classified according to UL94, Underwriters Laboratories, tests for flammability of plastic materials for parts in devices and applications. The plastic materials to be tested are classified based on tests with horizontal and vertical sample arrangements. In this case, HB means horizontal burning, whereas V-classifications describe a vertical burning test. HB-classification means that the material burns slowly, whereas the V-classifications indicate the different grades of flame-resistance and refer to the self-extinguishing characteristic of plastic materials in structural elements and parts of electric units and devices.

It should be noted in this context that these grades, determined under standard conditions, are of relative nature and are very often required as a precondition for the application, when manufacturing prefabricated parts. UL94 explicitly stresses that the igniting behaviour of prefabricated parts, made from plastic, also depends on shape and size of the parts, as well as the heat transfer and on the duration, intensity and consistency of action of the ignition source. For applications as a direct or indirect support part for current-carrying parts, UL94 requirements call simultaneously for the glow wire grades and the flame class; for further information please refer to A. Schulmann GmbH, Hüttenstraβe 211, 50170 Kerpen, Germany.

Furthermore, it is of particular advantage that the flame-resistant and/or self-extinguishing plastic material corresponds to the classification according to UL94-V0. The vertical burning test UL94-V0 describes self-extinguishing averaging less than 5 seconds, after the ignition source is removed, wherein individual values must not exceed 10 seconds. Possibly dripped particles of the plastic material, must not ignite a present cotton indicator, and afterglowing should be terminated after 30 seconds. Thus, a very high classification for self-extinguishing is given, wherein the inventive plastic material, as the utilized material in a door operator, may likewise comply with the classification UL94-V1, UL94-V2 and/or UL94-V5. It is valid in principle that an ignition duration of at least 10 seconds (HWI-value) is sufficient for V0 classified material, whereas an HWI-value of at least 30 seconds is required for an HB-material.

Furthermore, it may be provided that the plastic material complies with the classification UL94-HB, wherein the plastic material according to the HB-test method complies with the classification HB75, preferably with the classification HB40 and even more preferably with the classification HB: self-extinguishing. The indicated HB-classifications correspond to a distance of burnout in millimeters after one minute, after the ignition source is removed. The slower the burning velocity, the higher the safety of continued functioning of the door operator in the presence of an ignition source.

The inventive door operator may be formed as a mechanical door closer or as an electrically operated door drive. If the door operator is configured as a door closer, the latter has a spring force accumulator as a structural member, wherein the door closer may include enclosing parts, which, according to the present invention, are made from a flame-resistant and/or self-extinguishing plastic material. If the door operator is formed as an electrically operated door drive, the latter comprises an electrical drive, control electronics as well as several electrical terminals and associated modules. Both the components of the door drive itself and the enclosing parts belonging to the door drive, to which belong enclosure elements for example, may be made from the inventive plastic material.

For example one of the structural members of the door operator may represent a system carrier, in or at which the components of the door drive are disposed, wherein the system carrier, at least partially, is made from a flame-resistant and/or self-extinguishing plastic material. The system carrier constitutes the mechanical basic support of the door operator at which the electrical components, plug-in contacts, connecting modules and the like are disposed. If this basic support is made from a flame-resistant and/or self-extinguishing plastic material, the continued functioning of the mentioned components, in the presence of an ignition source, is improved. In particular the risk of an electrical short circuit building-up is reduced, if the plastic material has the fireproof features.

It can be furthermore intended, that at least one of the structural members represents a connecting module, which serves for receiving electrical connecting lines and/or connecting elements, and which, at least partially, is made from a flame-resistant and/or self-extinguishing plastic material. The mains connection of the door operator may be received in the connecting module, whereby the risk of a short circuit is in particular reduced if the plastic material of the connecting module is made from a flame-resistant and/or self-extinguishing plastic material. In this case, the components of the door operator do not have generally to be completely made from a fireproof plastic material; instead the components may include a multi-material system, such that at least one of the components of the multi-material system represents a corresponding fireproof plastic material.

According to a further advantageous embodiment of the inventive door operator, the latter includes an enclosure, which forms the exterior skin of the door drive, wherein the enclosure is made at least partially from a flame-resistant and/or self-extinguishing plastic material. The enclosure may form a hood, which, as a terminal structural member, is placed onto the door operator and may be in particular exposed to an external ignition source. If the material of the enclosure has flame-resistant and/or self-extinguishing features, in a particular way they may allow for a continued operation of the door operator in the presence of an ignition source.

Furthermore, it may be intended that the component made from a flame-resistant and/or self-extinguishing plastic material is produced in an injection molding process. Thus no disadvantages will result with regard to the capability of producing individual structural members of the door operator so that no considerable cost increases are incurred. The possibility of producing the plastic materials in an injection moulding process is given, if the components include for example a PVC, a PBT, a PA, a PC and/or an ABS plastic material. In this case PVC means polyvinyl chloride; PBT means polybutylene terephthalate; PA means polyamide; PC means polycarbonate; and ABS means acrylonitrile butadiene styrene. The above mentioned plastic materials may be respectively executed according to the classification UL94-V0 as flame-resistant and/or self-extinguishing plastic materials and are only mentioned by way of example.

### BRIEF DESCRIPTION OF THE DRAWING FIGURE

Further features enhancing the invention will be described in conjunction with the description of one preferred embodiment of the invention based on the sole figure, in which:

FIG. 1 shows an exploded perspective view of an embodiment of a door operator having several components, which are shown to be separated from each other.

### DETAILED DESCRIPTION OF THE EMBODIMENTS

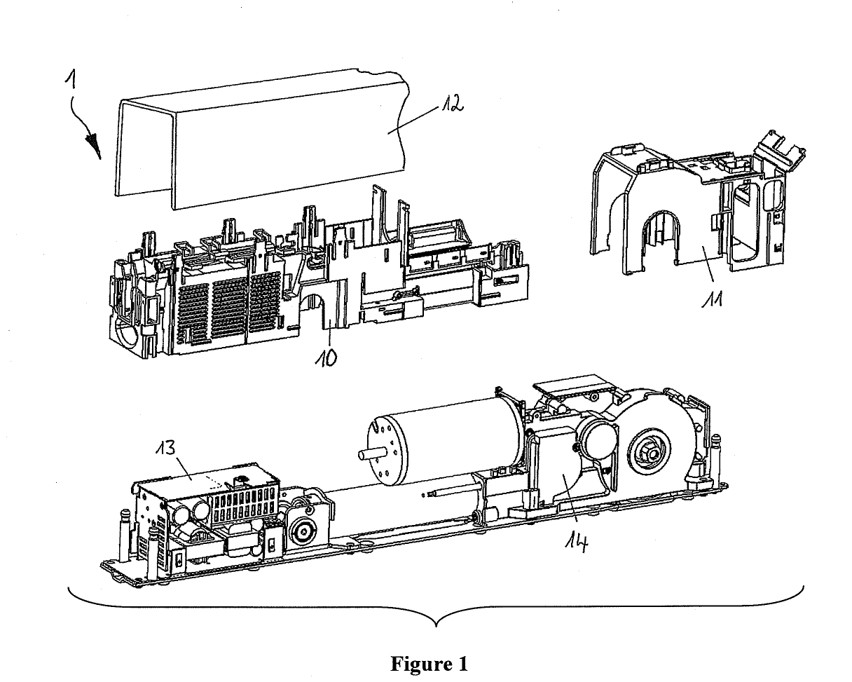

The door operator shown in FIG. 1 essentially consists of a system carrier 10, a connecting module 11 as well as an enclosure 12, wherein the mentioned structural members may be made from a plastic material, which is configured as a flame-resistant and/or self-extinguishing plastic material. The type and composition of the plastic materials of the various above mentioned structural members may differ from each other, wherein at least one of the above mentioned structural members has the flame-resistant and/or self-extinguishing features. In particular, plastic materials, which may experience a low thermal load, but a higher mechanical load, may be made from a different material than the plastic materials which experience a high thermal load with a lower mechanical load. In the event of an external ignition source, the enclosure 12 is exposed for example to a considerable thermal load, whereas the mechanical load plays a rather small role. On the contrary, the system carrier 10 may be exposed to a considerable mechanical load, whereas with an external ignition source and in the presence of the enclosure 12, the thermal load of the system carrier 10 is initially lower.

According to FIG. 1, several components of the door operator 1 are shown, which likewise may include a plastic material with a flame-resistant and/or self-extinguishing feature. The power supply unit 13 may have for example components made from plastic material having fireproof features. Furthermore, additional modules are shown, such as the additional module 14 for example, which represents an encoder. Even such additional modules 14 may have fireproof features, wherein the features for fire safety may be differently embodied.

The connecting module 11 receives the electrical terminals, which comprise for example the mains connection. The connecting module 11 may be preferably formed from a plastic material with a self-extinguishing feature, which is based on releasing an inert gas upon inflammation of the material of the connecting module 11, by means of the inert gas further burning of the material is prohibited. This feature may be further provided for the plastic material of the enclosure 12 and for all other plastic materials. On the other hand, by way of example, the plastic material of the power supply unit 13 or, by way of example, of the additional module 14 may be made from a heat-resistant plastic material, whereby the fire safety is likewise increased.

The system carrier 10 may be made from a plastic material compound, because the latter must have both an enclosure feature and a structural feature for receiving mechanical forces. As a consequence, the respective component of the compound material may represent a plastic material, which has a correspondingly higher mechanical quality, whereas other areas may have a higher self-extinguishing feature of the plastic material.

The embodied invention is not limited to the above presented preferred embodiment. A number of variants are conceivable, which make use of the described solution likewise with basically different types of formations. All features and/or advantages including the constructional details, spatial dispositions and process steps resulting from the claims, the description or the drawings, may be essential to the invention, both by themselves and in their various combinations. It may be in particular intended that the door operator 1 has essentially structural members made from regular plastic material without flame-resistant and/or self-extinguishing features. However, an essential structural member such as the enclosure 12 may comprise a plastic material made from flame-resistant and self-extinguishing material. As a consequence, to enhance the fire safety, existing door operators 1 may be retrofitted with enclosures 12 or further components which include the above mentioned fireproof features. Thus, in the presence of an external ignition source, continued operation of the door operator 1 is at least enhanced in the event of a fire.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A door operator for operating a door leaf of a door, the door operator having at least one structural member made from at least one of flame-resistant and self-extinguishing plastic material.

2. The door operator according to claim 1, wherein the at least one of flame-resistant and self-extinguishing plastic material complies with a classification according to UL94.

3. The door operator according to claim 1, wherein the at least one of flame-resistant and self-extinguishing plastic material complies with the classification according to UL94-V0.

4. The door operator according to claim 1, wherein the at least one of flame-resistant and self-extinguish plastic material complies with a classification UL94-HB and complies with a classification HB75 according to a HB-test method.

5. The door operator according to claim 1, wherein the door operator is configured as a mechanical door closer or as an electrically operated door drive.

6. The door operator according to claim 1, wherein the door operator is an electrically operated door drive, wherein the at least one structural member represents a system carrier, in or at which components of the door drive are disposed, and wherein the system carrier, at least partially, is made from the at least one of flame-resistant and self-extinguishing plastic material.

7. The door operator according to claim 1, wherein the at least one structural member is a connecting module, which serves for receiving at least one of electrical connecting lines and connecting elements, and which, at least partially, is made from the at least one of flame-resistant and self-extinguishing plastic material.

8. The door operator according to claim 1, wherein the at least one structural member represents an enclosure, which forms an exterior skin of a door drive, and wherein the enclosure, at least partially, is made from the at least one of flame-resistant and self-extinguishing plastic material.

9. The door operator according to claim 1, wherein the at least one structural member is manufactured in an injection molding process.

10. The door operator according to claim 1, wherein the at least one of flame-resistant and self-extinguishing plastic material of the at least one structural member is at least one of a PVC, a PBT, a PA, a PC and an ABS plastic material.

11. The door operator according to claim 4, wherein the at least one flame-resistant and self-extinguishing plastic material complies with a classification according to UL94-V0.

12. The door operator according to claim 4, wherein the at least one flame-resistant and self-extinguishing plastic material complies with a classification HB40 according to the HB-test method and with a classification HB self-extinguishing.

13. The door operator according to claim 3, wherein the at least one of flame-resistant and self-extinguish plastic material complies with a classification UL94-HB and complies with a classification HB75 according to a HB-test method.

14. The door operator according to claim 3, wherein the at least one flame-resistant and self-extinguishing plastic material complies with a classification HB40 according to the HB-test method and with a classification HB self-extinguishing.

15. The door operator according to claim 1, wherein the at least one structural member represents a system carrier, in or at which components of a door drive are disposed.

16. The door operator according to claim 1, wherein the at least one structural member represents a connecting module, which serves for receiving at least one of electrical connecting lines and connecting elements.

17. The door operator according to claim 1, wherein the at least one structural member represents an enclosure, which forms an exterior skin of a door drive.
